(19) United States
(12) Patent Application Publication
(10) Pub. No.: US 2006/0087760 A1
(43) Pub. Date: Apr. 27, 2006

(54) Simple method of protecting customer data on hard drives returned from the field

(75) Inventors: Thomas R. Forrer JR., Round Rock, TX (US); Jason Eric Moore, Austin, TX (US); Abel Enrique Zuzuarregui, Paige, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/970,462

(22) Filed: Oct. 21, 2004

(51) Int. Cl. G11B 15/04; G11B 19/02

(52) U.S. Cl. 360/60; 360/69

(57) ABSTRACT

A unique identification number is stored in the electronic card that is attached to a disk drive, as well as in a reserved location on the disk itself. This ID number is initialized at head-disk assembly and a match between the two ID numbers is necessary for access to the data on the disk, although not for repairs to the mechanisms themselves. When a disk containing sensitive data is to be removed from a customer site, a technician briefly removes the disk and applies a jumper to specific contacts on the drive, then reinserts the drive and powers it up. This causes the ID on the electronic card to be erased, rendering the data on the drive unreadable. When the drive reaches a repair facility, the erased ID number ensures that the disk will be reformatted before being reused.

### BACKGROUND OF THE INVENTION

1. Technical Field

The invention relates generally to protecting the privacy of user data. More specifically, the invention relates to preventing unauthorized access to information on a hard disk that is removed from a customer site and that will be reused with other customers.

2. Description of Related Art

When a technician is called to a customer's site for problems on a computer system, the customer is generally anxious to return the system to service as quickly as possible. This need can dictate that hardware components are replaced on site to restore the system to service, while a determination of the nature of the problem is made in a central repair facility to which the components are sent. Because of this policy, when a hard disk drive is removed from a customer's system during a repair process, the disk drive itself may or may not be defective. At the repair facility, needed repairs are made and then all working drives are placed in a pool for use as on-site replacements. Customers sometimes have concerns that sensitive data on a drive could be recovered from a drive when it is reused. In order to prevent this, customers have been known to damage the drive beyond repair, causing themselves and the repair company further expense. A need exists for a method to ensure that a customer's data is protected and cannot be easily retrieved, without damaging the drive.

### SUMMARY OF THE INVENTION

In the inventive method, a unique identification number is stored in the electronic card that is attached to a disk, as well as in a reserved location on the disk itself. This ID number is initialized at the head-disk assembly and a match between the two ID numbers is necessary for access to the data on the disk, although not for repairs to the mechanisms themselves. When a disk containing sensitive data is to be removed from a customer site, a technician briefly removes the disk and applies a jumper to specific leads of the drive, then reinserts the drive and powers it up. This causes the ID on the electronic card to be erased, rendering the data on the drive unreadable. When the drive reaches a repair facility, the erased ID number ensures that the disk will be reformatted before being reused.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A-1B respectively depict a perspective view and a partial cut-away view of a hard disk assembly in which an embodiment of the invention can be used.

FIG. 2A schematically depicts a bottom view of a hard disk assembly, showing the attachment of the electronics card, according to an exemplary embodiment of the invention.

FIG. 2B schematically depicts the available jumper points on a hard disk assembly, according to an exemplary embodiment of the invention.

FIG. 3 depicts a flowchart of the steps a technician takes at the customer worksite to protect the data on a removed disk, according to an exemplary embodiment of the invention.

FIG. 4 depicts a flowchart of the steps the hard disk would be subjected to at the repair facility, according to an exemplary embodiment of the invention.

### DETAILED DESCRIPTION OF THE PREFERRED EMBODIMENT

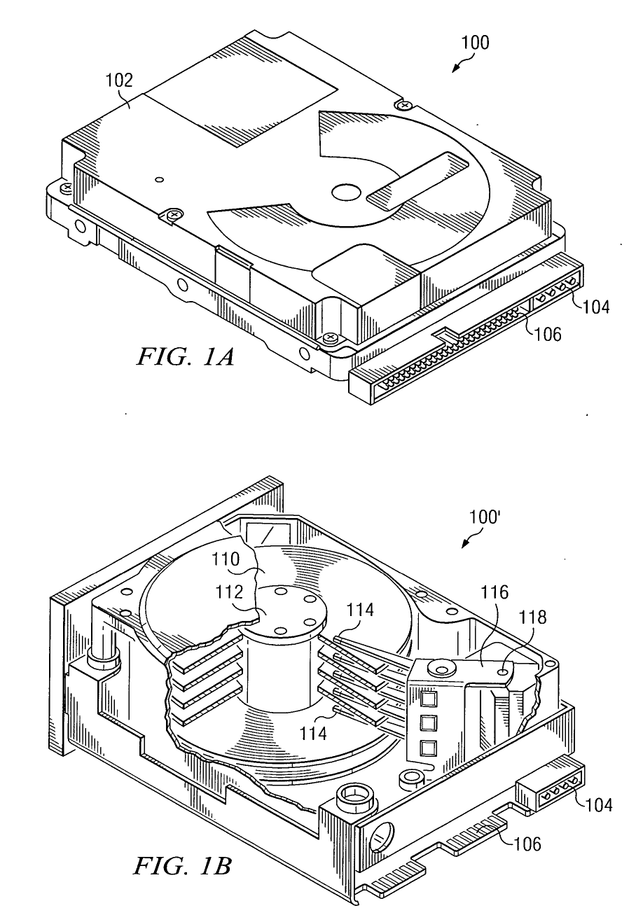

With reference now to FIGS. 1A-1B, a disk drive on which an embodiment of the invention can be used is shown. FIG. 1A depicts a perspective view of sealed hard disk drive 100. Casing 102 forms a sealed chamber which encloses the disk platters and drive mechanisms. Power connectors 104 provide electrical power to the device and bus connectors 106 provide connections for the electronics that control the card and for the transport of data to and from the disks.

FIG. 1B depicts a cut-away of a slightly different hard disk drive 100′ on which an embodiment of the invention can be used. Inside the sealed chamber of the disk drive are a number of disk platters 110 arranged on a spindle 112. Read/write heads 114 are carried on head arms 116 and controlled through head actuator 118.

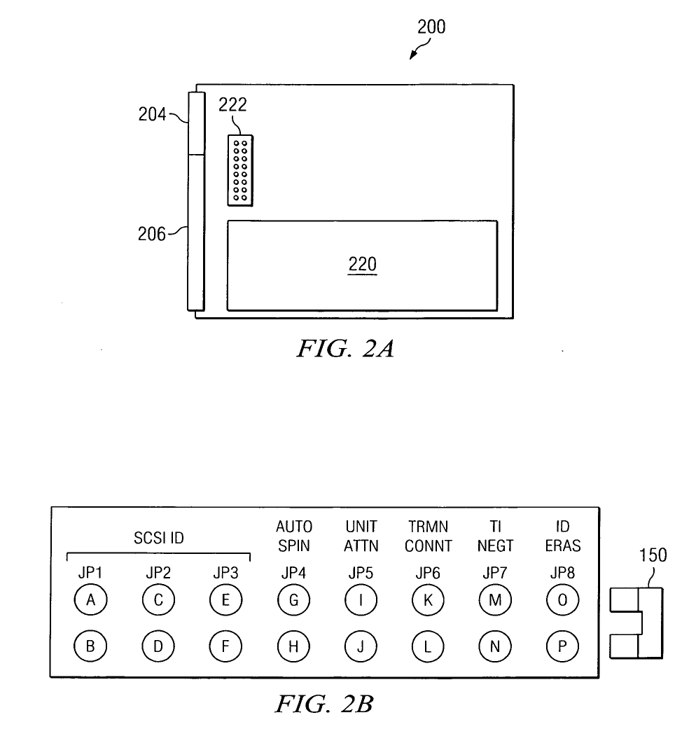

FIG. 2A depicts, in a more schematic manner, the backside of a sealed hard disk drive assembly 200. In addition to power connectors 204 and bus connectors 206, electronic card 220 is shown attached to the outside of the drive. Electronics card 220 contains the circuitry that controls the mechanical portions of the drive and passes the information to the system. Jumper locations 222 sit adjacent to logic card 220. Jumper locations are known in the art and can be used as a mechanical switch to enable or disable specific capabilities. Two contacts form each jumper location; a jumper can be inserted in the two contacts by a technician to close a specific circuit and cause a desired response. FIG. 2B depicts the arrangement of jumper locations into which jumpers can be applied, according to an embodiment of the invention. In the embodiment shown, sixteen contacts A-P are shown, although the number can vary. Each pair JP1-JP8 of contacts forms the location where a jumper 250, a small device that connects the two contacts, can be applied. In this exemplary embodiment, the presence or absence of jumpers 250 in JP1 through JP3 define a SCSI ID number for the device. JP4 through JP7 each define a property of the drive that can be enabled or disabled by the application of jumper 250. For example, the disk drive will spin up automatically after power on reset, unless a jumper in JP4 disables this capability. A jumper on JP5 will disable unit attention after power on reset or SCSI bus reset; a jumper in JP6 will enable the internal SCSI terminator; and a jumper in JP7 disables target initiated synchronous negotiation. In the exemplary embodiment, a jumper in JP8 will cause the unique ID number written on electronic card 120 to be erased on power-up.

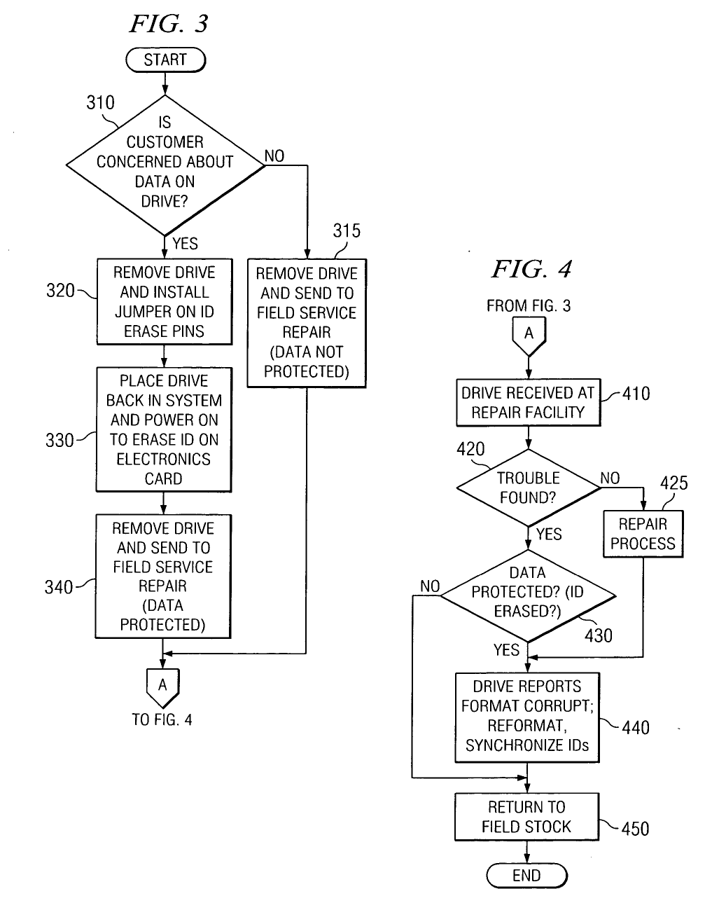

With reference now to FIG. 3, a method of protecting data on the disk will now be discussed, according to an exemplary embodiment of the invention. The discussed flow begins when a drive is about to be removed from a user's system. The technician first determines whether or not the customer is concerned about the data that resides on the disk (step 310). If the customer is not concerned about the data, the technician simply removes the drive. The drive will subsequently be returned to the repair center with unprotected data (step 315). However, if the customer is concerned about sensitive data, the technician temporarily removes the drive and installs a jumper across the contacts that cause erasure of the identification number (step 320). In the exemplary embodiment, a jumper is placed at JP8 on the disk drive. After the jumper is in place, the technician places the disk drive back into the system and powers the system on (step 330). With the jumper in place, powering up erases the identification number so that it no longer matches the identification number written to the disk itself. From this point on, the data on the disk is no longer available to anyone who attempts to read it. Finally, the disk drive is removed again and returned to the field service repair center for further attention (step 340).

With reference to FIG. 4, the handling of the disk drive once it arrives at the repair facility can be traced. The flow starts with the drive being received at the repair facility (step 410). The disk drive will first be tested to determine whether a problem exists with this piece of hardware (step 420). If repair is needed, the disk drive goes to a repair process for correction of the problem (step 425). When any repair is done to the drive a mismatch of identification numbers will occur, whether data protected or not. Thus, the drive will report format corrupted, so the disks are reformatted. By doing the reformatting the identification numbers on the disk and the electronics card are re-synchronized (step 440). This portion of the flow is as before. If no problems were found with the disk drive at step 420, it would normally be placed back in the pool of available drives. Under the inventive process, however, the electronics card is then checked to determine if the identification number has been erased (step 430), signifying that the data is protected. If the data is not protected, the disk drive can immediately be returned to field stock (step 450). If the data is protected, the disk drive will be treated as if it had been repaired; it will be reformatted and have its identification numbers resynchronized (step 440). Finally, the drive will be returned to field stock (step 450).

Using the disclosed method, a customer can be assured that their data is protected before the disk drive ever leaves their possession. This not only saves the customer money and creates greater satisfaction with the process; it also means that fewer drives will intentionally be destroyed, resulting in a savings in the time and material necessary to make a replacement.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A disk drive, comprising:
a plurality of disk platters connected to rotate about a common spindle;
a plurality of read/write heads connected to write information to and read information from respective ones of said disk platters;
a casing surrounding said plurality of disk platters and said plurality of read/write heads and providing a sealed environment; and
electronic circuitry connected to control the reading and writing of information on said plurality of disk platters;
wherein a unique identification number is written identically on said electronic circuitry and on a reserved area of one of said plurality of disk platters;
wherein data on said plurality of disk platters cannot be read if said identification number of said reserved area does not match said identification number of said electronic circuitry.

2. The disk drive of claim 1, wherein said electronic circuitry is carried on an electronic card that is attachable to the outside of said casing.

3. The disk drive of claim 1, wherein said electronic circuitry is connected to first and second contacts on a surface of said casing, said first and second contacts being configured to accept a jumper therebetween.

4. The disk drive of claim 3, wherein said electronic circuitry is configured such that powering up said disk drive while a jumper is in place between said first and second contacts causes said identification number of said electronic circuitry to be erased.

5. A method of operating a disk drive, comprising:
writing an identical, unique identification number to electronic circuitry that is attached to control a disk drive and to a reserved area of one of a plurality of disk platters that form said disk drive;
wherein data on said plurality of disk platters cannot be read if said identification number of said reserved area does not match said identification number of said electronic circuitry.

6. The method of claim 5, wherein said writing step is performed at the time the disk drive is assembled and at any subsequent reformatting of the drive.

7. The method of claim 5, further comprising the step of erasing said identification number of said electronic circuitry to make data on said disk drive inaccessible.

8. The method of claim 7, wherein said erasing step is performed by applying a jumper between first and second contacts on said disk drive and powering up said disk drive.
